(19) United States
(12) Patent Application Publication
(10) Pub. No.: US 2007/0033857 A1
(43) Pub. Date: Feb. 15, 2007

(54) Safeslide bobber apparatus

(76) Inventor: James Andrew Myers, McKinney, TX (US)

Correspondence Address: Michael Cameron, 2025 Savannah Drive, McKinney, TX, 75070, US

(21) Appl. No.: 11/474,203

(22) Filed: Jun. 26, 2006

Related U.S. Application Data
(60) Provisional application No. 60/707,317, filed on Aug. 12, 2005.
(60) Provisional application No. 60/717,002, filed on Sep. 15, 2005.

(51) Int. Cl. A01K 93/00

(52) U.S. Cl. 43/44.9; 43/41

(57) ABSTRACT

What is disclosed is a bobber with an interchangeable flotation portion attached or slid tightly over the top of a main body tube made of a clear or translucent material. A lightweight bobber stop or string can be coupled above the bobber on the fishing line to set fishing depth. The flotation portion is made of an impact resistant material, including expanded polystyrene, Styrofoam or plastic of a variety of shapes and sizes. Slots and apertures can be added to the submersible main body tube to reduce or release trapped air when the bobber is cast upon the water. The flotation portion could also be made of other closed cell foams which are adapted for flotation. Cork or air filled plastic could also be used as flotation portion. The main body tube can be made of any impact resistant material, including, but not limited to clear or translucent plastic and crystalline polystyrene, polyethylene or plastic.

### CROSS REFERENCE TO RELATED APPLICATIONS

This application claims the benefit of U.S. Provisional Application No. 60/707,317 filed on Aug. 12, 2005, entitled “SAFESLIDE BOBBER APPARATUS” and No. 60/717,002 filed Sep. 15, 2005, entitled “IMPROVED SAFESLIDE BOBBER APPARATUS”.

### TECHNICAL FIELD

The present invention relates to fishing hooks, lines, sinkers and related fishing lures and rigs.

### BACKGROUND OF THE INVENTION

A variety of fishing related apparatus are well known in the art. For example, in U.S. Pat. No. 4,075,777, a bait casting float in which bait to be protected is placed into a hollow end of the float, then cast upon the water, thereby saving the bait from damage as the float impacts in the water is disclosed. As seen therein, the float is of a thin-walled elongated configuration, being flared at one end and having an elongated nipple at the other end defining a flotation chamber. Air is maintained in the flotation chamber by means of a seated spherical ball trapping air in said chamber and which, in turn, is a flotation member. Such conventional apparatus has certain disadvantages that the present invention overcomes as will become clear from the discussion set forth herein.

### SUMMARY OF THE INVENTION

The present invention allows for the safe casting and retrieval of fishing hooks, lines and sinkers and other fishing lures or rigs, including additional embodiments. It further allows for less snagging or line hang-ups when reeling or retrieving a fishing rig. The present invention permits snag free storage and transport of a fishing rig and allows for standard jig fishing. The present invention advantageously can be used around water plants, trees and brush piles with fewer snags and hang-ups.

To those skilled in the art to which this invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

For a better understanding of the present invention including the features, advantages and specific embodiments, reference is made to the following detailed description along with accompanying drawings in which:

FIGS. 1A-1F are perspective and side views of the bobber of the present invention;

FIG. 2 is a bottom view of the bobber of the present invention;

FIG. 3 is a side view of the main tube body of the present invention;

FIG. 4 is a cross sectional view of the lower section of the main tube body of the present invention, illustrating the thick wall bead and bell shape thereof;

FIG. 5 is a view of the bobber stop used in the present invention;

FIG. 6 is a perspective view of a foam float used in the present invention;

FIG. 7 is a perspective view of the present invention without the float;

FIG. 8 is a perspective view of the bobber of the present invention;

FIGS. 9A-9E are additional aspects of the present invention; and

FIGS. 10A-10B are side views of a second embodiment of the bobber of the present invention.

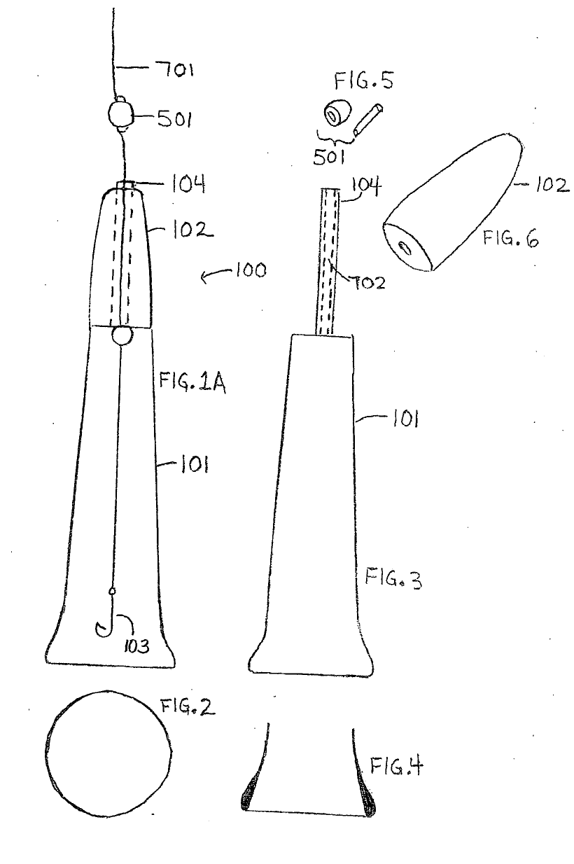

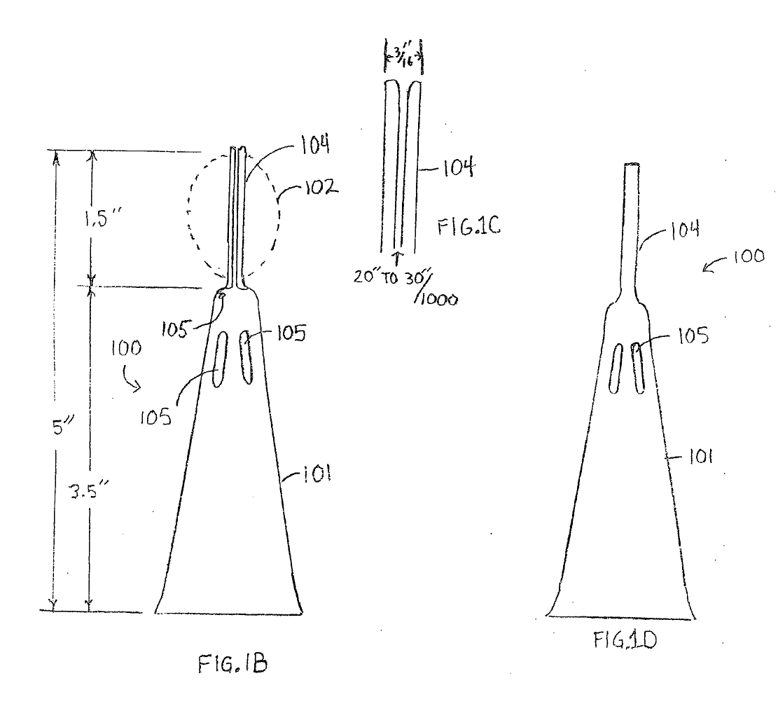

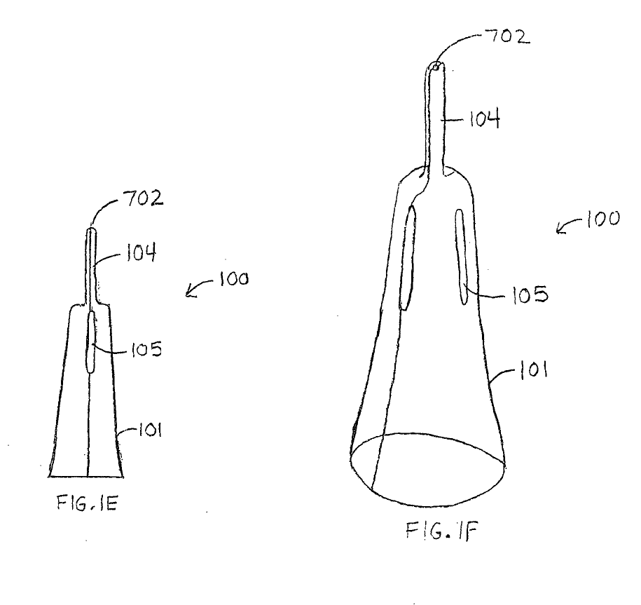

References in the detailed description correspond to like references in the Figures unless otherwise noted. Like numerals refer to like parts throughout the various Figures.

### DETAILED DESCRIPTION OF A PREFERRED EMBODIMENT

While the making and using of the preferred embodiment of the present invention is discussed in detail below, it should be appreciated that the present invention provides many applicable inventive concepts which can be embodied in a wide variety of specific contexts. Some features of the preferred embodiment shown and discussed may be simplified or exaggerated for illustrating the principles of the invention. The present invention advantageously makes fishing safer, easier and less worrisome, especially when fishing with and around children. It reduces dangerous hook snagging when fishing around others and animals such as dogs. Finally, the present invention reduces line snags on water plants, trees and shrubs.

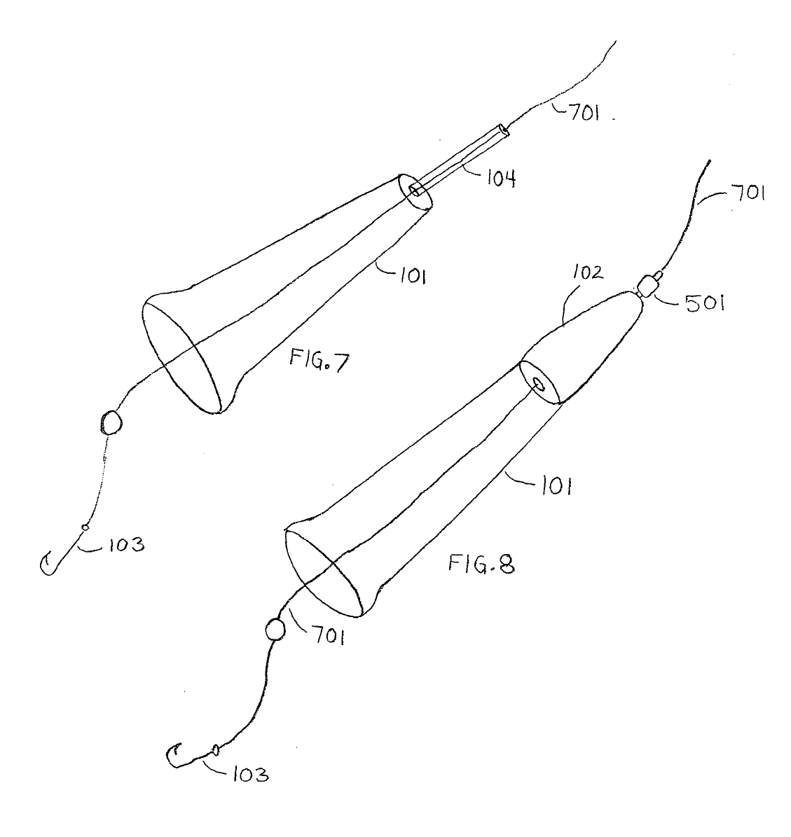

As seen in FIG. 1A, the present invention comprises a bobber 100 with an interchangeable flotation portion 102 attached or slid tightly over a stem portion 104 extending from the top of a clear or translucent main body tube 101. The flotation portion 102 can be made of a variety of materials, including expanded polystyrene or Styrofoam as seen in FIG. 6 and can be fashioned from a variety of sizes and shapes, including but not limited to cone, bullet, spherical, cylindrical and teardrop. The flotation portion 102 can also be made of other closed cell foams which are adapted for flotation. Cork or air filled plastic could also be used as flotation portion 102. As seen in FIGS. 1A-1F, 3, 7 and 8, the main body tube 101 can be made of a variety of impact resistant materials, including, but not limited to clear or translucent crystalline polystyrene or polyethylene, including with a co-polymer, poly carbonate or plastic. The plastic used is a self submersible plastic. FIG. 1B illustrates dimensions of one embodiment of the bobber of the present invention with a spherical flotation portion 102. Such dimensions are about 5 inches along the longitudinal axis, of which the main body tube 101 is 3.5 inches long and the stem portion 104 is about 1.5 inches long. The diameter of the opening at one end of the main body tube 101 which receives the fishing rig or hook is between about 1.5 and 2 inches. Different dimensions of the bobber can be manufactured depending on, among other things, the size of the fishing rig to be received and flotation portion 102. Exemplary embodiments can have lengths along the longitudinal axis of from 2 inches to 24 inches and a diameter at the end that accepts a fishing rig or hook of between about 1 inch and 4 inches. FIG. 1B also discloses float top holder 106, which comprises a cylindrical ring of a colored polyethylene or similar material which is adapted to fit snugly on the end of stem portion 104 so as to secure flotation portion 102 in place. FIG. 1C illustrates a close-up of stem portion 104 having a diameter of about 3/16 inches with bore 702 having an exemplary interior diameter of between 2/100 and ⅛ of an inch. FIGS. 1E and 1F illustrate that the main body tube 101 and stem portion 104 of bobber 100 can be manufactured in two (2) or more pieces for example in an injection molding process and welded sonically or with other attachment means such as a glue or in a heat process.

The main body tube 101 of the present invention is advantageously made of a clear, impact resistant material, such as plastic or clear polystyrene or the like, so as to be able to see the fishing rig without physically feeding the line out of the main body tube 101. In a preferred embodiment, the main body tube 101 is formed of a colored translucent material and yet be resilient enough to absorb significant force or energy without breaking. In contrast to conventional bobbers, the present invention completely houses a fishing rig. No portion of the hook 103 is exposed during casting of a line. Further the shape of the present invention is different from conventional bobbers in that is uses a float which is assembled to a stem portion 104 extending from the top of the main body tube 101. Referring to FIG. 5, an ultra-light weight plastic bobber stop 501 is used so that very small or lighter fishing rigs will go to the desired depth by easily pulling the bobber stop 501 to the top of the bobber 100 when in the water. The flotation portion 102 of the bobber 100 can comprise floats of different colors, shapes and sizes.

In operation, and as seen in FIG. 7, a fishing line 701 is fed down through a bore 702 formed within and through the longitudinal axis of the stem portion 104 extending from the main body tube 101, the stem portion 104 of which also holds a flotation device 102. The fishing line 701 is then attached to a fishing hook, sinker, bait or other fishing rig inside the main body tube. A bobber stop 501 is placed on fishing line 701 above the bobber to set the desired fishing depth. The main body tube 101 is submersed and assumes a vertical position under the water by virtue of slots and apertures 105 formed along the main body tube 101.

In operation, the flotation portion 102 of bobber 100 stays substantially above the water line. The fishing rig sinks to the desired depth in the water as determined by the bobber stop 501 as the bobber stop 501 is pulled down to the top of the flotation by the weight of the fishing rig. The lower portion of main body tube 101 is generally tapered in a funnel, cone, horn or bell shape to assist in preventing a hook from catching the edge when reeling up the rig and having slots and apertures 105 formed therein so that water will fill the main body tube 101 to assist in it becoming vertical faster. The slots and apertures drilled or formed into the lower main body tube 101 ensure that the main body tube 101 fills with water so as to facilitate the bobber 100 assuming a vertical position in the water. A main body tube 101 having a thicker wall or bead is an additional aspect of the present invention that assists the bobber 100 assuming a vertical position faster when it is cast into the water. In operation, the fishing rig stays inside the bobber 100 during casting. When retrieving or reeling in the fishing line 701, the fishing rig travels into the bobber 100 and the bobber 100 is retrieved to the bank or boat with the rig safely inside. As noted, in a preferred embodiment, the main body tube 101 is translucent so the user can see the bait and rig located within bobber 100. Bobber 100 can be held onto like a handle after landing a fish so that the user does not have to touch the fish if desired.

The flotation portion 102 and main body tube 101 of the present invention can be manufactured in different clear and fluorescent colors with contrasting color bobber stops. The present invention can be manufactured in different colors and shapes depending on the demographics of the consumer. The missile or cone tapered shape of the main body tube 101 of the present invention aids in easier retrieval of bobber 100 from tight hang-ups or snags. As seen in FIG. 5, the bobber stop is lightweight and of a diameter larger than the smallest fishing pole eyelets.

In another embodiment of the present invention, the stem portion 104 extending from the main body tube 101 and which holds the flotation portion 102 of the bobber 100 extends slightly out, beyond the top of the flotation portion 102 device. This configuration is adapted to reduce fishing line friction as the line passes back and forth through the bobber 100. Further, the main body tube 101 can also be designed and manufactured with an upper cup, cavity, or lip to secure or hold the flotation portion 102 in place. The cavity may vary in height from bobber to bobber depending on the size and shape of the flotation portion 102. The cavity is built in to have the main body tube 101 remain as one piece.

As seen in FIGS. 10A-10B, slots or apertures 105 can be added to the main body tube 101 to reduce or release trapped air when the bobber 100 is cast upon the water. These slots or apertures 105 are not limited in number, shape, size and location placed on the bobber 100. The number, shape, size and placement of the slots and apertures 105 may vary with different bobber styles. A fishing line can be threaded through a circular aperture 105 instead of through bore the of stem portion 104 when used with smaller rigs and lighter tackle that might otherwise not be heave enough to pull the line through the bore of stem portion 104.

As seen in FIGS. 10A and 10B, safety cap or plug 1001 can be inserted into the base of the main body tube 101 of bobber 100 for storage.

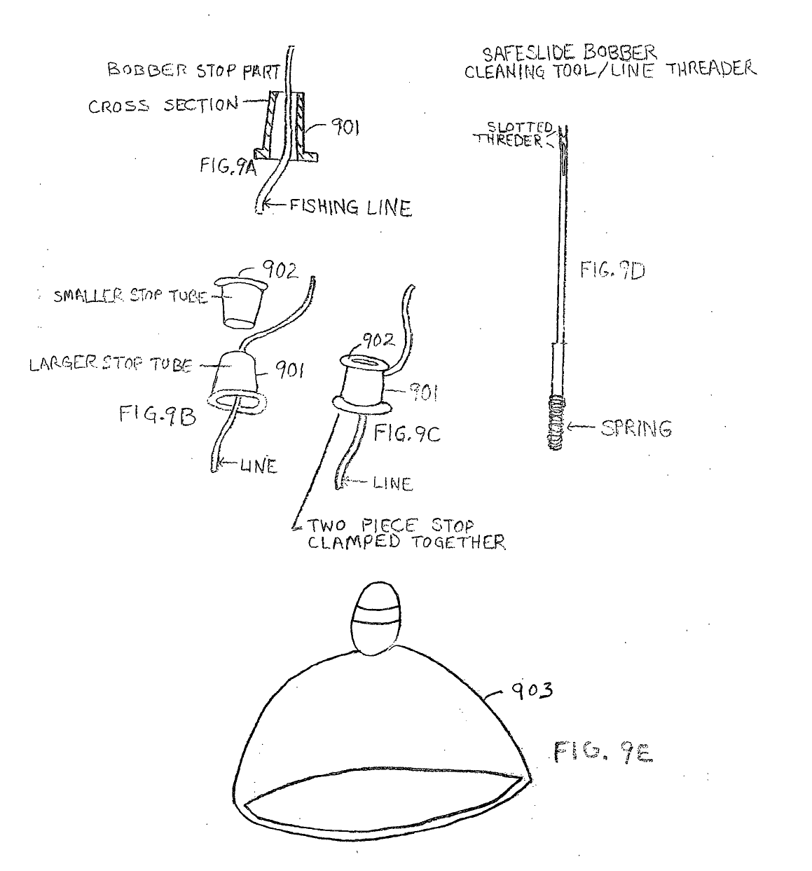

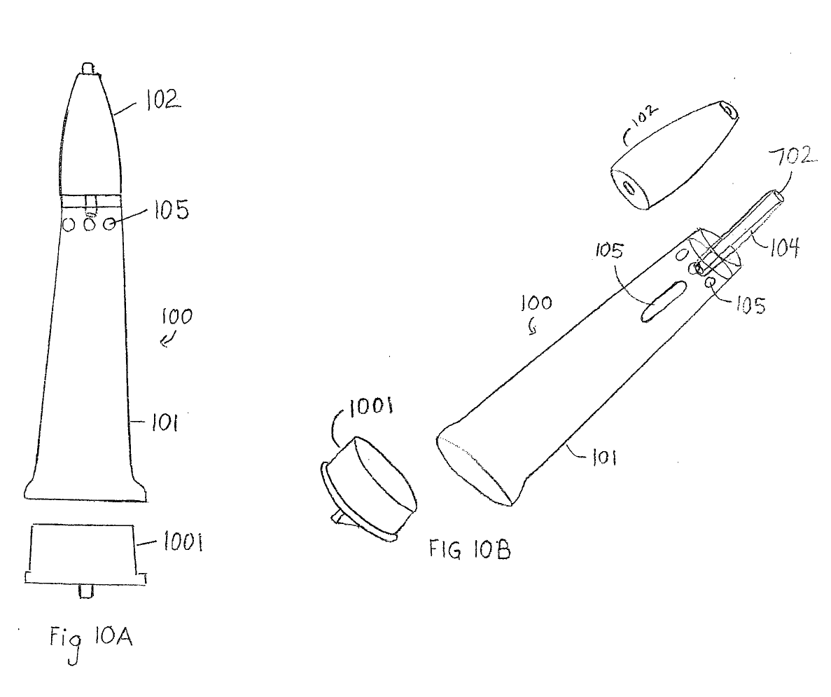

FIGS. 9A-9E illustrate additional aspects of the present invention.

To allow lighter weight fishing rigs to travel to the desired fishing depth as determined by a bobber stop, a lightweight bobber stop is needed. FIG. 9A illustrates a bobber stop cross section 901 for placement on the fishing line. FIGS. 9B and 9C illustrate a two piece stop 901, 902 clamped together. This bobber stop design is made of a two piece thin walled polyethylene or other comparable lightweight plastic. The two parts are short, hollow tube shaped plastic and flanged at one end as to not allow the bobber stop to pass through the smaller eyelet on the end of the fishing rod. The diameter of the flange section is preferably no larger of than one quarter of an inch. The fishing line can be passed through one of the two plastic flanged tubes and a second slightly smaller flanged tube is inserted tightly into the first tube, thus clamping onto the line. The bobber stop can be loosened and slid up and down the line to change to the desired fishing depth. The stem portion 104 may also be formed to extend down inside the main body tube 101 to reduce contact or friction of a fishing rig inside the top of the main body tube 101.

FIG. 9D illustrates a safeslide bobber cleaning tool and line threader having a slotted threader and spring. The stick can be made of plastic. It can have a small slotted end for insertion through the stem portion 104. The small end can be slotted to double as a fishing line threader. One end of the cleaning stick has a wider diameter and has a spring attached for cleaning the large tube end of bobber 100. FIG. 9E illustrates another embodiment of the present invention in the shape of a half-spherical dome 903 having an interior portion for receiving a fishing rig and a flotation portion coupled to the top thereof.

The embodiments shown and described above are only exemplary. Even though numerous characteristics and advantages of the present invention have been set forth in the foregoing description together with details of the invention, the disclosure is illustrative only and changes may be made within the principles of the invention to the full extent indicated by the broad general meaning of the terms used in the attached claims.

I claim:

1. A bobber apparatus comprising a main body tube adapted to accept therethrough a fishing line along the longitudinal axis thereof.

2. The bobber apparatus of claim 1, further comprising a stem portion extending from the top of the main body tube, the stem portion having a bore therethrough for accepting a fishing line and the stem portion adapted to accept an interchangeable flotation portion.

3. The bobber apparatus of claim 2, further comprising being manufactured of an impact resistant material.

4. The bobber apparatus of claim 2, further comprising being manufactured of a clear or translucent crystalline polystyrene or polyethylene material.

5. The bobber apparatus of claim 2, further comprising being manufactured of a clear or translucent plastic material.

6. The bobber apparatus of claim 2, further comprising being manufactured of a polycarbonate material.

7. The bobber apparatus of claim 6, wherein the plastic material further comprises a self submersible plastic.

8. The bobber apparatus of claim 1 having a measurement along a longitudinal axis of between 2 and 24 inches.

9. The bobber apparatus of claim 1 having a diameter of the end of the main body tube which receives the fishing rig or hook of between 1 inch and 4 inches.

10. The bobber apparatus of claim 2, in combination with a fishing line and fishing rig or hook.

11. The bobber apparatus of claim 10, further comprising a lightweight bobber stop attached above the bobber apparatus on a fishing line to set a fishing depth.

12. The bobber apparatus of claim 2, in combination with a flotation portion having a shape selected from a group consisting of cone, bullet, spherical, cylindrical and teardrop.

13. The bobber apparatus of claim 12, further comprising the flotation portion being made of a closed cell foam.

14. The bobber apparatus of claim 12, further comprising the flotation portion being made of a cork or air filled plastic.

15. The bobber apparatus of claim 1, further comprising the main body tube being made of a clear or translucent material.

16. The bobber apparatus of claim 1, further comprising the main body tube having slots and apertures formed or drilled therethrough operable to reduce or release trapped air when the bobber is cast into the water.

17. The bobber apparatus of claim 1, in combination with a safety cap or plug for safely storing the bobber.

18. A safeslide bobber apparatus comprising:
a main body tube and a stem portion extending from the main body tube and adapted to accept therethrough a fishing line along the longitudinal axis thereof; and
the stem portion adapted to accept a flotation portion;

19. The safeslide bobber apparatus of claim 18, in combination with a solid cone or bullet shaped flotation portion.

20. A bobber cleaning stick, having a first, small slotted end for insertion through the small tube of a bobber and a second end having a spring attached for cleaning the large tube end of the bobber.
